(19) United States
(12) Patent Application Publication
(10) Pub. No.: US 2004/0207200 A1
(43) Pub. Date: Oct. 21, 2004

(54) Low profile connection detail

(76) Inventors: Nikhil Baxi, Cordova, TN (US); Thomas Lee Howard, Southhaven, MS (US); Phillip Oglesby Bowers, Paragould, AR (US)

Correspondence Address: Joseph J. Pophal, PARKER-HANNIFIN CORPORATION, 6035 Parkland Boulevard, Cleveland, OH, 44124-4141, US

(21) Appl. No.: 10/819,833

(22) Filed: Apr. 7, 2004

Related U.S. Application Data
(60) Provisional application No. 60/463,519, filed on Apr. 15, 2003.

(51) Int. Cl. F16L 5/00

(52) U.S. Cl. 285/205

(57) ABSTRACT

An assembly for fluidly connecting two components in a refrigerant system comprised of a tube and a plate. The tube has a first end, a second end, a bent portion between the first and second end, a through-hole extending from the first end to the second end, and an annular bead radially extending around the exterior of the tube. The plate has a first end surface, a second end surface, and a bore extending from the first end surface to the second end surface for receiving the tube. At least a part of the tube bent portion is received within the plate bore, and the tube is affixed to the plate at the first end surface.

### CROSS-REFERENCE TO RELATED CASES

The present application claims the benefit of the filing date of U.S. Provisional Application Serial No. 60/463,519 filed Apr. 15, 2003, the disclosure of which is expressly incorporated herein by reference.

### FIELD OF THE INVENTION

The present invention relates to connector assemblies having a plate with an affixed tube for fluidly connecting two components within a refrigerant system. In particular, the present invention relates to lock block assemblies and the method of affixing a bent tube to its receiving plate.

### BACKGROUND OF THE INVENTION

Connector assemblies for fluidly joining components within a refrigerant system are well known in the art. These assemblies are typically referred to as lock block assemblies. Lock block assemblies are comprised of a tube and plate. The plate receives the tube such that one end of the tube extends from one side surface of the plate while the other end of the tube extends from the other side surface of the plate. The tube is affixed within the plate that is affixed to a component within the system.

Prior art lock blocks have plate/tube assemblies in which the tube is straight on both sides of the plate. In order to connect both ends of the tube to componentry within the refrigerant system an adapter or connecting hose assembly is needed. The linking adapter or connecting assembly adds a further component to the system which unconstructively adds a further leak path. It is advantageous to eliminate the adaptive component.

Once affixed, it is imperative that the tube not move relative to the plate. Since the tube is aligned between the components within the system, any movement negatively affects this sealed alignment. Prior art lock blocks with straight tubes can use several techniques for attachment. One of these is brazing the tube to the plate. Another is swaging the tube into the plate receiving bore. Still another is forming, with a punch press, a bead from the tube into the plate bore. Both the swaging and the punch techniques are practical with straight tubes but not with a bent tube. The bend in the tube provides an obstacle when attempting to expand the inside of the tube. There is great difficulty in forming a bead in the bent area of the tube.

In order to provide a secure lock block assembly with minimal leak paths, it is desirable to have a tube with a bend as close to the plate as possible. This minimizes the number of components in the system and reduce the possible leak paths. It is desirable to affix the tube to the plate with a cost effective, practical process so that a dependable connection is made between the tube and plate.

### SUMMARY OF THE INVENTION

The present invention provides a connector assembly for connecting components within a refrigerant system. The assembly is comprised of a plate with a tube extending there through. A feature of the present invention is that the tube has a first end, a second end, a bent portion between the first and second ends, a through-hole extending from the first end to the second end and an annular bead radially extending around the exterior of the tube. The plate has a first end surface, a second end surface, a bore extending from the first end surface to the second end surface for receiving the tube. Further, at least a part of the tube bent portion is received within the plate bore, and the tube is affixed to the plate at the first end surface of the plate.

A further feature has the noted plate being staked to the tube at least two positions. Another feature has the at least two staked position are on the bent portion of the tube. Still another feature of the noted assembly has the plate first bore being symmetrical about its longitudinal axis. Another attribute of the noted assembly has the plate being of the die-cast variety. Still a further attribute of the noted assembly has the affixation of the plate to the tube occurring at the bent portion of the tube. Still yet another feature of the present invention has the plate having a second bore extending from the first surface to the second surface for receiving a fastener for affixing the plate to one of the components. A further feature has the tube with an annular bead radially extending from its exterior in abutting contact with the plate second end surface, axially located between the tube second end and the tube bent portion, for sealing contact with one of the refrigerant system components.

Another feature of the present invention provides a method of forming an assembly of a tube and a plate. The tube has a first end, a second end and a longitudinal passage extending from the first end to the second end. The plate has a first end surface, a second end surface and a bore extending from the first end surface to the second end surface. The noted method comprises a first step of bending the tube, followed by positioning the tube within the plate bore such that at least a portion of the bent section of the tube is received within the bore. The noted method then orientates the longitudinal axis of the tube relative to the plate, followed by affixing the plate to the tube.

A further feature of the noted method has, in addition to the step of affixing the plate the tube, affixing the plate to the bent section of the tube. Still, another feature of the noted method has the step of affixing the plate to the tube being a process of staking. Yet another feature of the noted method includes, prior to bending the tube, the additional step of forming a bead on the tube generally at the tube second end. Further features and advantages of the present invention will become apparent to those skilled in the art upon review of the following specification in conjunction with the accompanying drawings.

### BRIEF DESCRIPTION OF THE DRAWINGS

FIG. 1 is a side sectional view showing a lock block connection assembly according to the present invention.

FIG. 2 is a side sectional view showing a tube used in the lock block assembly detailed in FIG. 1.

FIG. 2a is a side sectional view showing a tube, similar to that detailed in FIG. 2, that can be used with the lock block assembly of the present invention.

FIG. 3 is a frontal view showing a plate of the lock block connection assembly of FIG. 1.

FIG. 4 is a side sectional view showing the plate of the present invention lock block assembly.

FIG. 5 is a rear view of the lock block assembly according to the present invention.

### DETAILED DESCRIPTION OF THE PREFERRED EMBODIMENTS

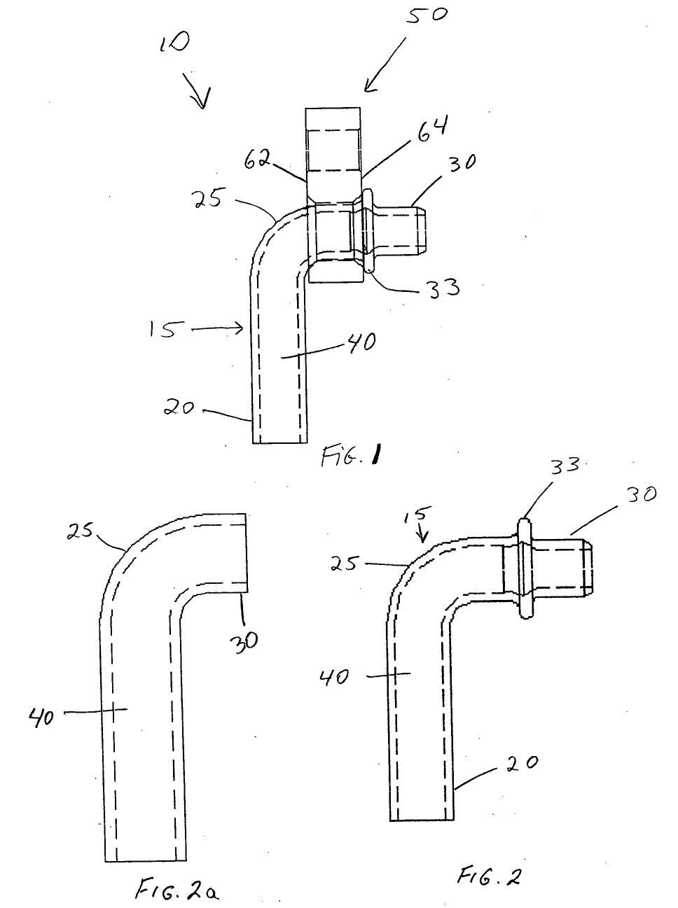

Referring to FIG. 1, a connector assembly, or lock block, 10 according to the present invention is shown. Assembly 10 is generally comprised of a tube 15 that is received within a plate 50. Connector assembly 10 is used to fluidly connect components within a refrigerant system. For example, tube 15 has a first end 20 that can connect with an accumulator or compressor (not shown) while a second end 30 can connect with an evaporator (not shown). Connector assemblies, or lock blocks, are well known in the refrigerant system art and are used as connectors for various components.

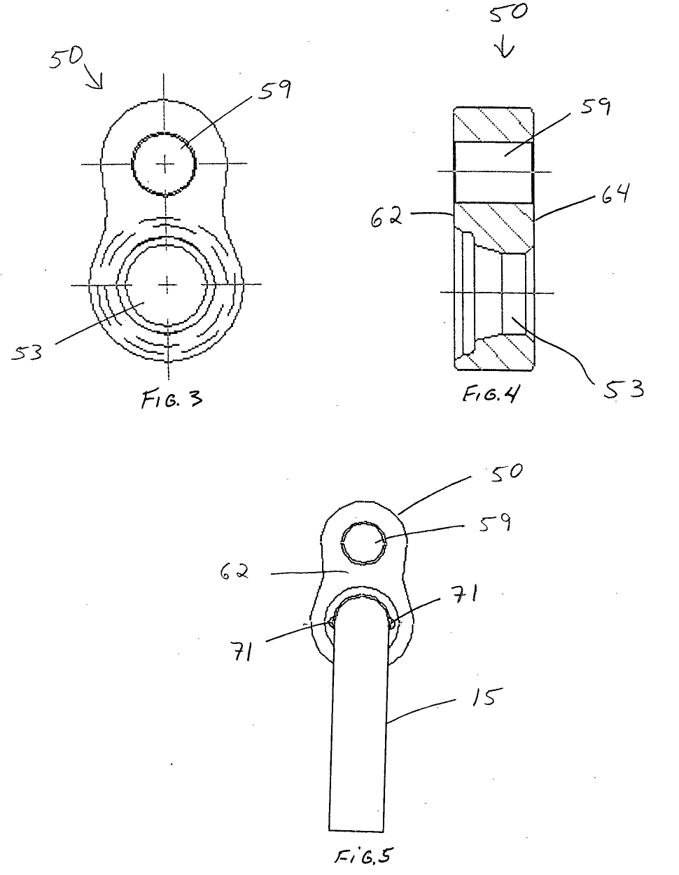

Referring to FIGS. 1, 3 and 4, plate 50 has a first bore 53 that receives tube 15 and a second bore 59 which receives a fastener (not shown) that affixes connector assembly 10 to a plate on the refrigerant system component, e.g. the evaporator. Both first and second bores 53, 59 extend from a first end surface 62 of plate 50 to a second end surface 64. Although the diameter of first bore 53 changes throughout its axial extent, it is symmetrical about its longitudinal axis. This symmetry allows tube 15 to rotate within bore 53 prior to being affixed with plate 50. Although plate 50 can be formed with various techniques, the preferred one is for plate 50 to be cast from a die.

Referring to FIGS. 1 and 2, tube 15 has a longitudinal bore 40 that extends from first end 20 to second end 30. Tube 15 has a radially extending annular bead 33 located near second end 30. When lock block assembly 10 is fastened to the system component (not shown), second end 30 is received within a port of the component and bead 33 provides a seal at this joint. It should be noted that tube 15 could have a beadless configuration, as shown in FIG. 2a, if a bead is not needed for sealing second end 30 with the system component. Tube 15 has a bent portion 25 located between first end 20 and second end 30. Although lock block assembly 10 shows tube 15 bent at 90°, other angles could be used.

Referring to FIGS. 1-5, the fabrication of lock block assembly 10 will now be discussed. Referring to FIG. 2, tube 15 starts as a straight tube without bead 33. Bead 33, if needed, is formed on tube 15 by a method well known in the art, e.g. by punching means. Once bead 33 is formed, tube 15 is bent to a desired angle, for example 90°. Next, tube first end 20 is slid through plate first bore 53 until bead 33 is in contact with plate second end surface 64. Tube 15 is then rotated to its desired orientation and affixed to plate 15. The preferred method of affixing tube 15 to plate 50 is by a staking process. Specifically, assembly 10 is inserted into a staking machine, tube 15 is oriented (relative to plate 50) to its designed position, and plate 50 is staked into tube 15. More specifically, tube first end surface 62, in a location (indicated by element number 71) close to the orifice for first bore 53, is deformed inwardly (or towards tube 15) by staking into tube 15. Preferably plate 50 is staked at two locations 71.

An important feature of lock block assembly 10 is that bent portion 25 is captured inside of plate bore 53 and that plate 50 is staked into tube bent portion 25. That is, bent portion 25 is permanently retained between first and second end surfaces 62, 64 so that the clearance between plate first end surface 62 and the longitudinal axis of tube first end 20 is minimized. By minimizing this clearance, tube first end 20 can directly connect with the system component rather than having to connect with an additional adapter or assembly in order to provide a fluid connection. Further, if tube 15 did not have a bend (as is well known in the art), another angled adapter would have to be attached to tube first end 20 (by brazing or threading) in order to provide a fluid connection with the system component. Again this could potentially add a further leak path.

With lock block assemblies such as assembly 10, it is necessary to affix tube 15 to plate 50 at end surface 62. Affixing tube 15 to plate 50 at end surface 64 could negatively alter bead 33 and disrupt the sealed joint between tube second end 30 and its mating component. As indicated above, in refrigerant systems it is desirable to have the bent portion of tube 15 as close as possible to plate 50. It is preferable to have tube bent portion 25 within plate 50. The present invention has achieved this goal with bent portion 25 being received and retained within bore 53 since affixing plate 50 with tube 15 is accomplished by staking. This is not possible with other forms of attachment other than by brazing. For example, it is common in the art to affix the tube to the plate with a punched bead. Since it is desirable to have bent portion 25 within plate bore 53, a bead can not be formed on bent portion 25 of tube 15. Further, any tube with a bead can not be bent (at the beaded portion) without adversely affecting the bead.

Another form of affixing tube 15 within plate bore 53 could be accomplished by swaging tube 15 into plate bore 53. Swaging can not be performed, with ease, at bent portion 25 of tube 15. Bending tube 15 after swaging it into bore 53 could negatively affect the swaged joint. While it is possible to affix tube bent portion 25 to plate 50 with a braze joint, this joint is not as reliable as a joint with a completely round tube. Since the tube-plate connection is made at bent portion 25, tube 15 is likely to be out of round which interferes with the capillary action as the braze flux melts. The large gap created by the out of round bent portion 25 relative to round bore 53 increases potential for contamination during processing as well as providing voids in the braze joint that creates a leak path and a joint vulnerable to stress concentrations.

It is desirable to have plate 15 be of the die-cast variety since the plate material is relatively soft internally and hard externally, which helps retain tube 15 within plate 50. Die cast plate 15 is also easier to stake when compared with plates manufactured by other means. It should be noted that although plate 50 is preferred to be of the die-cast type, other manufactured forms of plates, e.g. machined or extruded, could be used.

It should be once again noted that even though FIG. 1 shows tube 15 bent at 90°, the bend could be at any desired angle while capturing bent portion 25 within bore 53. Also, although FIG. 5 shows the longitudinal axis of tube 15 aligned with the center of both bores 53, 59, tube 15 could be oriented in any position relative to plate 50.

It should be noted that the present invention is not limited to the specified preferred embodiments and principles. Those skilled in the art to which this invention pertains may formulate modifications and alterations to the present invention. These changes, which rely upon the teachings by which this disclosure has advanced, are properly considered within the scope of this invention as defined by the appended claims.

What is claimed is:

1. An assembly for fluidly connecting two components in a refrigerant system comprised of:
i. a tube having a first end, a second end, a bent portion between said first and said seconds ends, a through-hole extending from said first end to said second end, and an annular bead radially extending around the exterior of said tube;
ii. a plate having a first end surface, a second end surface, a bore extending from said first end surface to said second end surface for receiving said tube, wherein
iii. at least a part of said tube bent portion is received within said bore, and said tube is affixed to said plate at said first end surface.

2. The assembly as in claim 1 wherein said plate is staked to said tube at at least two positions.

3. The assembly as in claim 2 wherein said at least two positions are on said bent portion of said tube.

4. The assembly as in claim 1 wherein said plate bore is symmetrical about its longitudinal axis.

5. The assembly as in claim 1 wherein said plate is of the die-cast variety.

6. The assembly as in claim 1 wherein said affixation of said plate to said tube occurs at said bent portion of said tube.

7. The assembly as in clam 1 wherein said plate further has a second bore extending from said first surface to said second surface for receiving a fastener for affixing said plate to one of said components.

8. A connector used in a refrigerant system for fluidly connecting two components, comprised of:
i. a plate having a first end surface, a second end surface and a bore longitudinally extending from said first end surface to said second end surface; and
ii. a tube received within said plate bore and affixed to said plate, having a first end extending out said first end surface, a second end extending out of said second end surface and an intermediate bent portion between said first and second ends having at least a portion positioned within said bore.

9. The connector as in claim 8 wherein said tube is affixed to said plate at the first end surface of said plate.

10. The connector as in claim 9 wherein said tube bent portion is affixed to said plate.

11. The connector as in claim 10 wherein said affixing of said tube to said plate is by staking at least two points of said plate to said tube.

12. The connector as in claim 8 wherein said plate further has a second bore extending from said first end surface to said second end surface for receiving a fastener for attaching said connector with one of said components in said refrigerant system.

13. The connector as in claim 12 wherein said tube has an annular bead radially extending from its exterior in abutting contact with said plate second end surface, axially located between said tube second end and said tube bent portion, for sealing contact with one of said refrigerant system components.

14. The connector as in claim 8 wherein said tube has an annular bead radially extending from its exterior in abutting contact with said plate second end surface, axially located between said tube second end and said tube bent portion.

15. The connector as in claim 8 wherein said bore is symmetrical about its longitudinal axis.

16. The connector as in claim 8 wherein said plate is of the die-cast variety.

17. A connector used in a refrigerant system for fluidly connecting two components, comprised of:
i. a plate having a first end surface, a second end surface and a bore longitudinally extending from said first end surface to said second end surface; and
ii. a tube affixedly received within said plate bore, having a first end extending out said first end surface, a second end extending out of said second end surface and an intermediate bent portion between said first and second ends located in close proximity to said first end surface of said plate.

18. A method of forming an assembly of a tube and a plate wherein said tube has a first end, a second end and a longitudinal passage extending from said first end to said second end, said plate has a first end surface, a second end surface and a bore extending from said first end surface to said second end surface, comprising the steps of:
i. bending said tube;
ii. positioning said tube within said plate bore such that at least a portion of the bent section of said tube is received within said bore;
iii. orientating the longitudinal axis of said tube relative to said plate; and
iv. affixing said plate to said tube.

19. The method as in claim 18 wherein the step of affixing said plate to said tube includes affixing said plate to the bent section of said tube.

20. The method as in claim 18 wherein the step of affixing said plate to said tube is a process of staking.

21. The method as in claim 18 including, prior to bending said tube, the additional step of forming a bead on said tube generally at said tube second end.

22. A method of forming an assembly of a tube and a plate for fluidly connecting components in a refrigerant system wherein said tube has a first end, a second end and a longitudinal passage extending from said first end to said second end, said plate has a first end surface, a second end surface, a first bore extending from said first end surface to said second end surface, and a second bore extending from said first end surface to said second end surface comprising the steps of:
i. forming an annular bead radially extending around the exterior of said tube;
ii. bending said tube;
iii. positioning said tube within said plate bore such that at least a portion of the bent section of said tube is received within said bore, said annular bead adjacently abuts said second end surface of said plate;
iv. orientating the longitudinal axis of said tube relative to said plate; and
v. staking said first end surface of said plate to said bent section of said tube.

23. The method as in claim 22 wherein said staking step further includes staking two locations of said first end surface of said plate into said bent section of said tube.
